(19) United States
(12) Patent Application Publication
(10) Pub. No.: US 2004/0224294 A1
(43) Pub. Date: Nov. 11, 2004

(54) Simulated, interactive training lab for radiologic procedures

(76) Inventors: Raymond H. Heininger, St. Peters, MO (US); Dennis Hoffmann, St. Louis, MO (US); Timothy Stumpf, St. Charles, MO (US); Milton Griffin, Matteson, IL (US); George Brown, Bolingbrook, IL (US)

Correspondence Address: Clyde I. Coughenour, 16607 Sutton Place, Woodbridge, VA, 22191, US

(21) Appl. No.: 10/721,222

(22) Filed: Nov. 26, 2003

Related U.S. Application Data
(60) Provisional application No. 60/429,386, filed on Nov. 27, 2002.

(51) Int. Cl. G09B 23/28

(52) U.S. Cl. 434/262

(57) ABSTRACT

Radiology healthcare providers are trained or evaluated by solving practical patient problems using computer, 3D virtual imaging or manikins associated with software obtained from radiological equipment found in treatment facilities. The software is created from equipment functions and parameters. The trainee dynamically controls the environment and equipment to get results that are compared to expert solutions programmed into the computer.

### RELATED U.S. APPLICATION DATA

Provisional Application Ser. No. 60/429386 filed Nov. 27, 2002

### BACKGROUND OF THE INVENTION

1. Field of the Invention

Healthcare providers are trained to use radiological equipment by obtaining information on the equipment and its operation, gathering procedures followed by experts, incorporating the information into software and using it with visual images, a manikin, etc. The trainee then is given a problem to solve after which that solution is compared to the expert's solution.

2. Description of Related Art

While computer-based training (CBT) has exploded with applications for soft skill training, like team building and customer service, hard skill training has not yet benefited from CBT because developing applications to train employees in a virtual world has been cost prohibitive.

The use of automation and simulation per se for training and evaluation is well known in the art. As examples, Ingenito et al (U.S. Pat. No. 4,915,635, issued Apr. 10, 1990) use a manikin, control system, and simulators, for use by a student practicing procedures on the human body, such as cardiopulmonary resuscitation. Ostby et al (U.S. Pat. No. 5,326,270, issued Jul. 5, 1994) teach a method and apparatus for simulating a problem situation and recording responses using a touch-sensitive screen display with the results used for training or assessment; Beach et al (U.S. Pat. No. 6,361,323, issued Mar. 26, 2002) evaluate health care procedures using a point-tracking system and simulated clinical procedures performed on a simulated object; K. Linberg (U.S. Pat. No. 6,386,882, issued May 14, 2002) provides software-based simulation training and certification of program managers using a training request from an expert data center that provides a simulated training module for skill-based training, the results are analyzed for scoring and certification; Miranda et al (U.S. Pat. No. 6,457,975, issued Oct. 1, 2002) use a data processing system to evaluate trainee selection of critical and non-critical cognitive/functional tasks while using a virtual reality device with monitoring; McMenimen et al (U.S. Pat. No. 6,514,079, issued Feb. 4, 2003) use computer audiovisual presentations, multimedia teaching, and learning for performance and occupational skills; Schmieding et al (U.S. P.P.A. 2002/0048743 published Apr. 25, 2002) use an interactive template for guidance and training surgical skills including the use of literature, diagrams, drawings and graphics for visualizing procedural steps; C. Aman (U.S. P.P.A. 2002/0076679, published Jun. 20, 2002) teaches trainee interaction with a simulated medical device with feedback to determine competence in handling control of instruments displayed as graphical user interfaces on a trainee responder computer; Anderson et al (U.S. P.P.A. 2002/0137014, published Sep. 26, 2002) teach making a three-dimensional model or simulation of a patient from scanned volume images such as x-rays, MRI, CT, US, angiography, etc.

### SUMMARY OF THE INVENTION

The present process combines the knowledge of experts in radiologic procedures, with access to actual patient treatment facilities, equipment manufactuerer electronic diagrams, learning management systems software, and the use of Virtual Reality software that supports reuse. The training of healthcare providers to operate radiological equipment is personalized and automated by collecting pertinent information on equipment available in a radiological facility, their parameters, and operating procedures, that are converted into software form. Expert patient analysis and radiation evaluation are also converted into software form. By use of a manikin, 3D imaging, etc. the trainee performs patient problem solutions that are compared with the expert's recommended procedures for trainee evaluation.

This invention describes both a process and an application of simulation software integrated with learning management software technology. Included is the process of capturing product information on radiological equipment and creating a computer generated, three dimensional, full-scale, interactive, virtural training environment. This Virtual Training Enironment (VTE) will allow students, x-ray technologists, radiologists, maintenance technicions, and other key personel to interact with and simulate the use of equipment without risking patient radiation overdose and thus increasing the duration and quality of time spent practicing mandatory and elective radiological procedures. The integration of Learning Management System software will allow the monitoring and tracking of student, staff, employees as they use and develop knowledge working with the VTE.

### BRIEF DESCRIPTION OF THE DRAWINGS

FIG. 1 is an introduction to the process/system.

FIG. 2 is a picture of the controls for the equipment.

FIGS. 3 and 4 are depictions of standing positioning and equipment alignment.

FIGS. 5 and 6 are depictions of prone positioning and alignment.

FIG. 7 is a flow chart of procedures that can be followed.

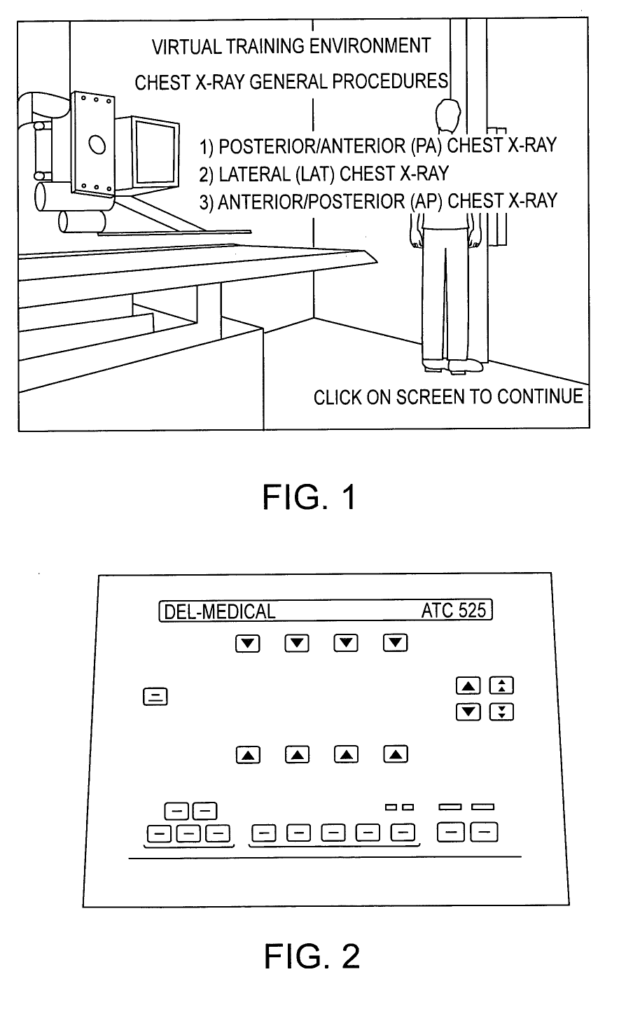

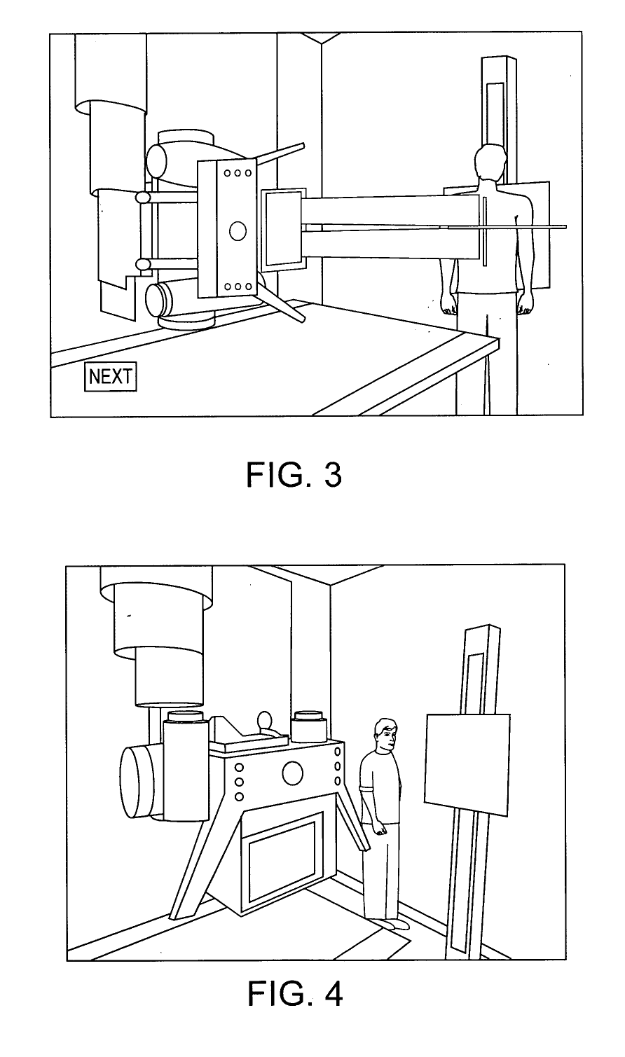

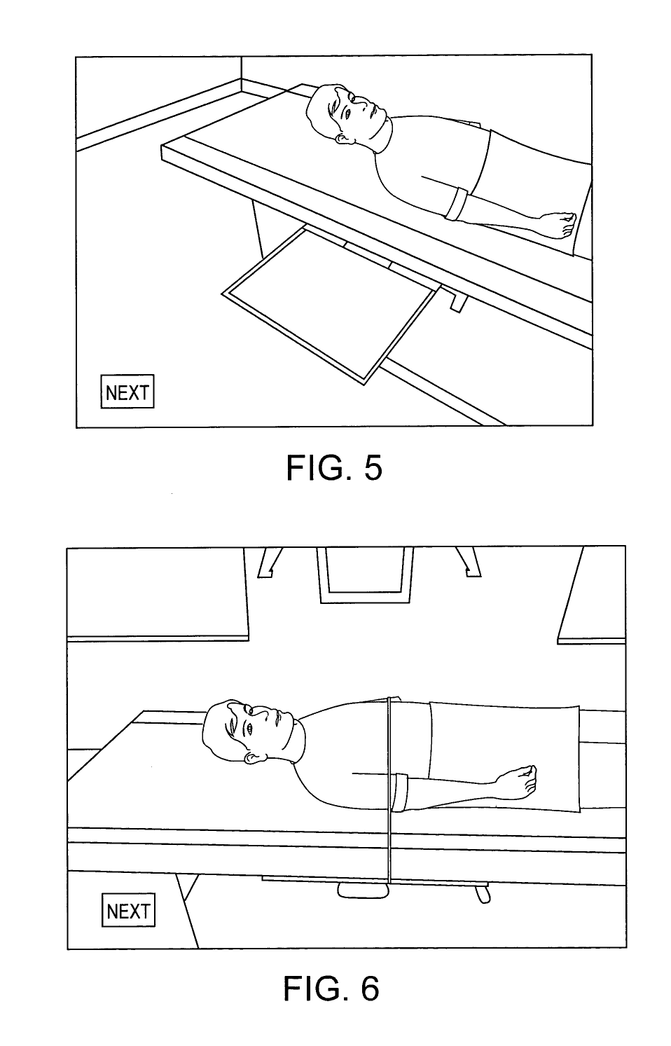

### DESCRIPTION OF THE PREFERRED EMBODIMENTS

This invention describes the process of procuring information on radiological equipment and creating a computer generated, three dimensional, full-scale, interactive, virtual training environment. This Virtual Training Environment (VTE) allows students, x-ray technologists, radiologists, maintenance technicians, and other key personnel to interact with and simulate the use of equipment.

A process is devised that combines the knowledge of experts in radiologic procedures, with access to actual patient treatment facilities, equipment, manufacturer electronic diagrams, learning management systems software, and the use of Virtual Reality software that supports reuse.

This invention will have the capacity and flexibility to support key imaging modalities (i.e. General X-Ray, CT and MRI); the capacity of the product to support simulation of mandatory and elective radiological procedures for clinical competency requirements for eligibility for the American Registry of Radiologic Technologists (AART) certification; to incorporate force-feedback gloves and/or sensor-enabled physical manikin interaction with a virtual manikin; to add the screen view and evaluation of the virtual image that results from the technique used—overexposed, underexposed, correct, etc.; and to provide virtual environment for manufacturing technicians to simulate assessing and servicing equipment.

Capturing and creating the VTE data about the radiology equipment included reviewing detailed vendor drawings, measuring the equipment, and capturing digital images of the equipment. Using the drawings and the measurements taken, 3D computer aided solid models were created and stored on digital media. These 3D models were converted from the solid model CAD definition to a polygonal format that is then prepared for acceptance of a texture map. Texture maps are then generated from a combination of digital images and textual information created from a multi-media application. These texture maps are then mapped to the 3D models. The 3D models are then assembled in the VTE, where algorithms about their constraints, interactions, and behaviors are applied and combined with various views to develop the unique combination of interactions and simulations.

This process simulates and provides the user with the ability to interact with all activities; technologist-to-patient, technologist-to-equipment interactions, equipment technique setting for radiological procedures for the clinical competency requirements. This virtual environment includes simulating and interacting with the 3D imaging room, 3D equipment, and the 3D patient. The process and technology allows the user of the 3D virtual training environment to read and listen to the training task description, select the appropriate device in the virtual training environment with a computer mouse, witness the device's appropriate response, then select, with the computer mouse, the “Next” button which allows the user to retrieve the next set of audio and text instructions, thus progressing through the tasks in a self-pace manner.

The overall instructional strategy is based on the concept of a blended learning approach. Blended learning involves the coordinated use of multiple instructional strategies to enhance traditional training methods and to take maximum advantage of new technology-based solutions to training delivery. The backbone of the instructional strategy is a Learning Management System (LMS). An LMS is software that automates the administration of training events. Its functions include managing the login of registered users, managing course catalogs, recording data from learners, and providing reports to management. In addition, the LMS is used to track student training, perform competency management, and direct the completion of certification and/or compliance training.

This training features the delivery of traditional types of training and PC-based VR products delivered via Distance Learning or ADL. PC-based, VR products that allows technologists, students and radiologists to interactively participate in simulated x-ray techniques, using life-like manikins and tactile sensitive gloves. The LMS will aid in managing and coordinating instructor-led events and simulation/hands-on events, the delivery of WBT and self-paced CBT. Web-based training and self-paced CBT enable student participation without instructor intervention and without the need for the traditional classroom setting

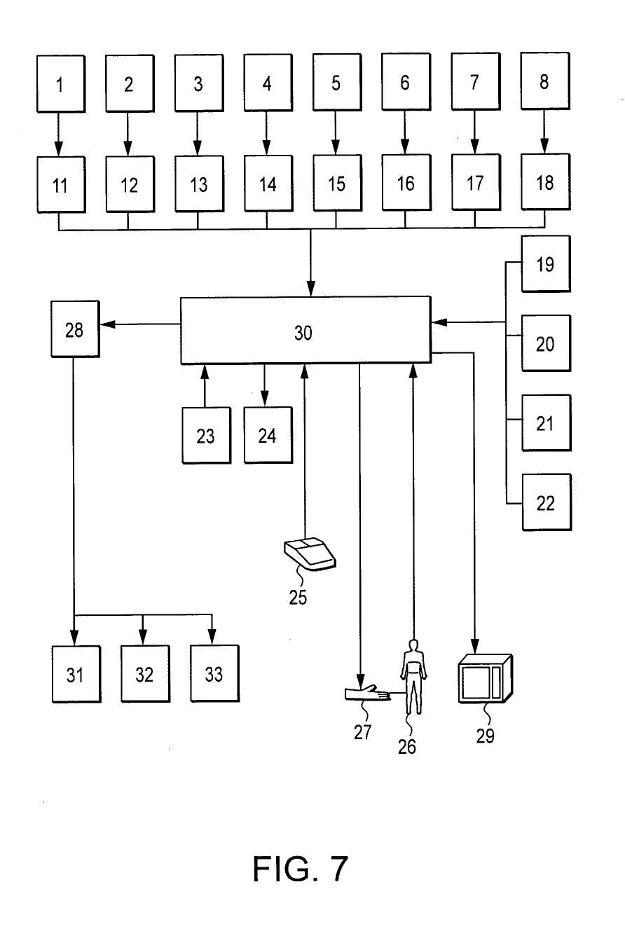

With reference to the flow chart of FIG. 7, the input to the computer includes:

1. Determining facility equipment available, including but not limited to x-ray, CT, MRI, ultrasound, nuclear medicine, cardiac catherization, mammography, position emission tomography.

2. Determining operating procedures for each piece of equipment.

3. Determining operating parameters for each piece of equipment.

4. Determining all patient problems each piece of equipment can assist in diagnosing.

5. Determining from experts the best equipment to use for each specific patient problem.

6. Determining from experts the best operating procedures/parameters, for each piece of equipment for revealing each specific patient problem, solution or diagnosis.

7. Determining from experts the interpretation for the results obtained from equipment used.

8. Determining techniques used for servicing equipment.

The information is used for:

11. Creating software representing each piece of equipment available.

12. Creating software representing operating procedures for each piece of equipment available.

13. Creating software representing parameters for each piece of equipment.

14. Creating software representations of all problems each piece of equipment can assist in diagnosing.

15. Creating software representations of best equipment to use for each specific patient problem as determined by experts.

16. Creating software representing the best operating procedures/parameters for each piece of equipment for revealing each specific patient problem diagnosis as determined by experts.

17. Creating software for interpreting the results obtained from equipment used as determined by experts.

18. Creating software for determining service techniques for the available equipment.

19. Creating software representing the optimum operating procedures for trainees.

20. Creating software of virtual images for trainees to work on.

21. Creating 3D interactive virtual images for trainees to interact with.

22. Creating software of “American Registry of Radiological Technologists certification requirements.

23. Providing trainees with a practical patient problem to be solved.

24. Providing dynamic trainee control over the environment and equipment software available.

25. Providing means for trainee interaction with equipment such as a mouse.

26. Creating a virtual manikin that trainee can practice on or interact with that emulates the equipment/patient contact and use.

27. Creating interaction with force feedback gloves and sensors to enable trainees to interact with manikin and equipment in virtual environment.

28. Providing integration with Learning management Software for creating and retaining a record of all procedures performed by trainees.

29. Providing a monitor for viewing equipment and simulated patients.

30. Computer

Retrieving output from the computer for:

31. Reviewing procedures followed by trainees.

32. Screen viewing and evaluating procedures followed by trainees.

33. Comparing procedures followed by trainees with optimum procedures outlined by experts.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A process for training healthcare providers procedures for using radiological equipment comprising:
obtaining available operating procedures for radiological equipment used in treatment and training facilities;
creating a computer software representation of said radiological equipment operating procedures;
obtaining operating parameters for each piece of radiological equipment;
creating computer software representative of the operating parameters for each piece of radiological equipment;
establishing optimum operation procedures from experts to be followed for various given patient problems;
creating computer software representation of said optimum operating procedures;
presenting a trainee with a practical problem that involves use of said radiological equipment in said treatment facility;
obtaining the procedures used by the trainee to solve the problem presented;
comparing the procedures followed by the trainee with the optimum operating procedures established by the experts.

2. A process for training procedures as in claim 1 including:
creating said computer software representation of said radiological equipment so as to create computer-generated three-dimensional full-scale interactive virtual images.

3. A process for training procedures as in claim 2 including:
simulating the use of said radiological equipment by having the trainee interact with said computer-generated three-dimensional image.

4. A process for training procedures as in claim 1 including:
creating said computer software representation of said radiological equipment so as to create a virtual reality image.

5. A process for training procedures as in claim 1 including:
obtaining said available information on radiological equipment so as to include x-ray, CT and MRI, ultrasound, nuclear medicine, cardiac catheterization, mammography, positron emission tomography.

6. A process for training procedures as in claim 1 including:
creating computer software representation of the American Registry of Radiologic Technologists certification requirements for comparison with problem solutions to support simulation of the mandatory and elective radiological procedures.

7. A process for training procedures as in claim 1 including:
providing a virtual manikin for student problem solution interaction.

8. A process for training radiological procedures as in claim 7 including:
incorporating force-feedback gloves and sensor-enabling physical manikin interaction to demonstrate trainee competence.

9. A process for training procedures as in claim 1 including:
providing screen viewing and evaluation of virtual imaging that results from trainee techniques used.

10. A process for training procedures as in claim 1 including:
providing a virtual environment for manufacturing techniques to simulate accessing and servicing of radiological equipment used.

11. A process for training procedures as in claim 1 including:
obtaining available information that includes capturing and creating the VTE data on radiology equipment drawings, measurements and digital images of the radiological equipment used.

12. A process for training procedures as in claim 1 including:
presenting the trainee with a computer based presentation of optimum operating procedures.

13. A process for training procedures as in claim 1 including:
obtaining patient problems each piece of equipment can assist in diagnosing;
creating computer software representation of patient problems each piece of equipment can assist in diagnosing.

14. A process for training procedures as in claim 1 including:
obtaining expert opinion on the best equipment to use for specific patient problems;
creating computer software representation of the best equipment to be used for evaluating patient problems.

15. A process for training procedures as in claim 1 including:
obtaining expert interpretation of results obtained from the radiological equipment used;
create computer software representative of expert interpretation of results obtained from equipment use.

16. A process for training procedures as in claim 1 including:
recording the procedures performed by the trainee.

17. A process for training procedures as in claim 1 including:
Interfacing with Learning Management Systems Software for recording, documenting and scoring the procedures and tests performed by the trainee.

18. A process for training procedures as in claim 13 including:
obtaining expert opinion on the best equipment to use for specific patient problems;
creating computer software representation of the best equipment to be used for evaluating patient problems;
providing screen viewing and evaluation of virtual imaging that results from trainee techniques used.

19. A process for training procedures as in claim 3 including:
providing a virtual manikin for student problem solution interaction;
incorporating force-feedback gloves and sensor-enabling physical manikin interaction to demonstrate trainee competence.

20. A process for training procedures as in claim 15 including:
providing screen viewing and evaluation of virtual imaging that results from trainee techniques used.
